(19) United States
(12) Patent Application Publication
(10) Pub. No.: US 2005/0127198 A1
(43) Pub. Date: Jun. 16, 2005

(54) Method for producing aerosol/resonance cavities (bubbles)

(76) Inventors: Vyacheslav Nicholaevich Brezhnev, Novosibirsk (RU); Anatoly Anatolievich Okhlopkov, Novosibirsk (RU); Galina Leonidovna Brezhneva, Novosibirsk (RU); Lidiya Dmitrievna Sidorova, Novosibirsk (RU); Aleksandr Vladimirovich Pryanichnikov, Novosibirsk (RU)

Correspondence Address: LADAS & PARRY, 26 WEST 61ST STREET, NEW YORK, NY, 10023, US

(21) Appl. No.: 10/503,877

(22) PCT Filed: Oct. 23, 2002
(86) PCT No.: PCT/RU02/00463

(30) Foreign Application Priority Data
Feb. 7, 2002 (RU) 2002103034

(51) Int. Cl. B05D 1/00; B05B 17/00; B05B 17/04; A62C 5/02

(52) U.S. Cl. 239/1; 239/8; 239/4

(57) ABSTRACT

The present invention relates to methods for producing an aerosol and may be useful in chemical, petrochemical and pharmaceutical industries, as well as in household applications, in medicine. The method for producing an aerosol consists in subjecting the medium to be dispersed to the action of ultrasonic oscillations with the help of a source of oscillations, containing a piezoelectric element. The source of oscillations is made with a possibility of dispersing a liquid and/or loose medium and adjusting the size of aerosol drops by varying the oscillations, the liquid and/or loose medium to be dispersed being acted upon in a standing-wave mode. The frequency of oscillations is varied within a range close to the resonance frequency of the macrostructure of the liquid and/or loose medium to be dispersed, and/or is maintained equal to the resonance frequency of the macrostructure of the liquid and/or loose medium to be dispersed. A fine-dispersed aerosol is formed, with a size of drops not larger than 0.5 μm, followed by regeneration of the dispersed medium macrostructure, i.e., of the geometry of the total active surface (which, essentially, intensifies the selected physicochemical process)

The present invention relates to methods for producing an aerosol (as well as a gel or cavitation bubbles) and to controlling physicochemical processes in a heterophase medium (or media). The invention may be useful in chemical, petrochemical and pharmaceutical industries, as well as in household applications, in medicine, and also in units for preparing fuel mixtures in internal combustion engines (for instance, in a diesel engine nozzle).

It is known that in heterophase systems, e.g., such as a gaseous reaction medium—catalyst surface, in the course of reaction (phase transition) there takes place an effect of origination of surface macrostructures (from islets of reagents, intermediate products). The geometrical type of such structures strictly corresponds to the reaction dynamics (see [1]-[4]). For instance, in [11] experimental results on SAWRS-control over the process of growth of semiconductor films in CVD-chambers are discussed. The existence of autocatalytic growth effects and the origination of surface submillimeter macrostructures controlling the reaction rates are shown. It should be noted that for the reactions on the “gas-solid” interface characteristic resonance frequencies lie within 0.8-10 MHz (in the general case, the characteristic dimensions of the microstructures are 0.1-15 mm). This limits substantially the linear dimensions of the catalyst (support) excited by ultrasound for induced creation of the required macrostructures. For industrial (large-scale) application it is therefore expedient to use aerosols or gels (prepared “separately”) such that their particles per se are the required macrostructures, i.e., have natural frequencies that are characteristic of the selected reactions. It should be noted that submicron drops of viscous liquids (for instance, of oils) have low-frequency megahertz natural modes of oscillations owing to “self-consistent” volume-surface excitations.

Closest to the present invention is the known method of producing an aerosol, consisting in that the dispersed medium is subjected to the action of ultrasonic oscillations by means of a source of oscillations comprising a piezoelectric element. [5].

The known method is disadvantageous in a low effectiveness of the catalytic activity of the formed macrostructures, i.e., in a low effectiveness of dispersing the medium, conditioned by low selectivity of the process of formation of macrostructures (of aerosol, gel or cavitation bubbles). When liquid catalysts are used, degradation of the macrostructures in the course of the physicochemical process is a particularly topical factor responsible for lowering the effectiveness of the proposed method.

The essence of the invention is, in particular, to enhance the efficiency of dispersing owing to intensive regeneration of macrostructures, providing resonance growth of the rate of physicochemical process.

The posed problem is solved by that the medium to be dispersed, which is usually multicomponent, is subjected to the action of ultrasonic oscillations with the help of a source of oscillations comprising a piezoelectric element. The source of oscillations, which is made with a possibility of dispersing a liquid and/or loose medium and adjusting the size of aerosol drops by varying the oscillation s, the liquid and/or loose medium to be dispersed is acted upon in a standing-wave mode. The frequency of oscillations is varied within a range close to the resonance frequency of the macrostructure of the liquid and/or loose medium to be dispersed, and/or is maintained equal to the resonance frequency of the macrostructure of the liquid and/or loose medium to be dispersed, i.e., the resonance frequency lies within the band(s) of the resonant growth of the rate of the process of for—mation (escape) of aerosol drops (gel drops or cavitation bubbles). During the process, oscillations are maintained in the system, which ensure regeneration of the relief of the selected macrostructure—of an ensemble of the obtained medium interfaces, which produces an effect of catalytic acceleration of the process. Upon formation (escape) of aerosol drops a fine-dispersed aerosol is formed with the size of drops not exceeding 0.5 μm, followed by the regeneration of the macrostructure of the dispersed medium, i.e., of the geometry of the total active surface (which, essentially, intensifies the selected physicochemical process).

The invention is explained by the accompanying drawings.

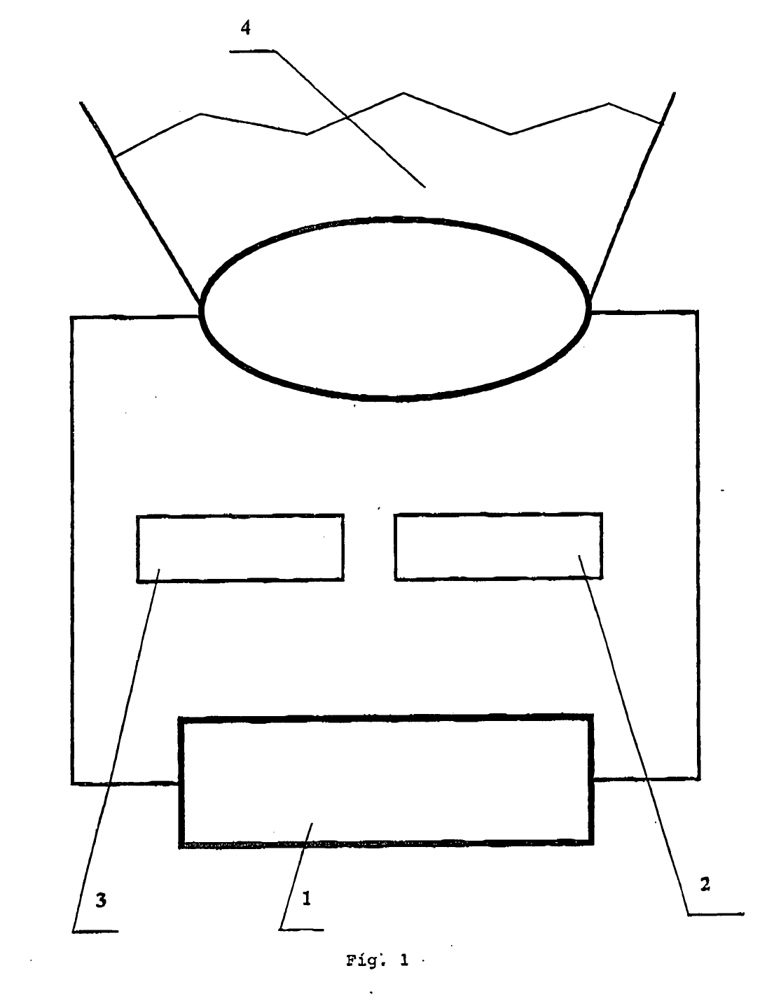

FIG. 1 shows a device for carrying out the claimed method.

The method for producing an aerosol consists in that a medium to be dispersed is subjected to the effect of ultrasonic oscillations with the help of a source of oscillations, comprising a piezoelectric element which is made with a possibility of dispersing a liquid and/or loose medium and adjusting the size of aerosol drops by varying the oscillations, the liquid and/or loose medium to be dispersed is acted upon in a standing-wave mode. The frequency of oscillations is varied within a range close to the resonance frequency of the macrostructure of the liquid and/or loose medium to be dispersed, and/or is maintained equal to the resonance frequency of the macrostructure of the liquid and/or loose medium to be dispersed. A fine-dispersed aerosol is formed with the size of drops not exceeding 0.5 μm, followed by the regeneration of the macrostructure of the dispersed medium, i.e., of the geometry of the total active surface (which, essentially, intensifies the selected physicochemical process). It should be noted that in carrying out said method, in particular, when producing ultradispersed liquid aerosols, the surface of the liquid medium acts as the process catalyst. Microdrops of a suitable size per se are macrostructures having a characteristic acoustic resonance frequency, i.e., in the present case, the catalyst relief is an ensemble of the aerosol drop surfaces, and therefore, having measured the characteristic resonance frequency of the medium (or media) being dispersed (for example, as disclosed in [10]), we can provide the creation (and regeneration) of a relief of macrostructures accelerating the selected physicochemical process (of dispersing), by generating ultradispersed drops. Naturally, it is expedient to maintain the relief of the selected macrostructure in the system by exciting a standing wave pattern at the given frequencies [10] by creating the relief mechanically: by selecting the injector channel geometry, by creating regular lattices in the areas of flow velocity steps, etc. The simplicity of generating aerosols of liquid media (liquids), as well as gels or bubbles, makes it possible to use effectively resonance effects when working with liquid catalysts on tremendous active surfaces (as compared with the wavelengths).

The device for carrying out the claimed method comprises an amplifier element 1 of a generator, a piezoelectric element 2 of the evaporation system embraced by a positive feedback loop 3, serving as a base oscillatory circuit which presets the generator oscillation frequency, a medium 4 to be dispersed, which is in acoustic contact with the piezoelectric element.

An aerosol is produced in the following manner. When the generator consisting of the elements 1 and 2 embraced by a positive feedback loop 3 is enabled, electric oscillations are generated. These electric oscillations are converted in the piezoelectric element 2 into a standing acoustic wave which acts on the medium (e.g., liquid) 4. Under the effect of acoustic action of the piezoelectric element 2, a process of dispersing the liquid 4 starts therein, which is accompanied by the origination of surface macrostructures to which there correspond characteristic acoustic resonance frequencies. The processes associated with the macrostructures originating in dispersing the (desired) liquid component vary the acoustic characteristics of the surface of the piezoelectric element at the characteristic resonance frequencies. The generator is controlled by the positive feedback loop 3 which amplifies the signals characterizing the action of the desirable processes in the liquid 4 being dispersed on the overall performance of the connected oscillatory circuits.

For example, a device realized on said principles can be used for dispersing essential oils of medicinal plants. Ultradispersed aerosols of oils thus produces are noted for a high sanifying (bactericidal) effect, this being associated with the resonant growth of the chemical activity of the surface of microdrops. This makes it possible to “catalyze” the biological interaction of the aerosol and bacteria, whereby the sanifying effect is substantially enhanced. The claimed method enables an essential broadening, in particular, of the field of medicinal application of essential oils of medicinal plants. The device operation at megahertz frequencies with densities of the ultrasonic active power on the order of 1 W/cm² makes it possible to produce aerosols with the diameter of drops smaller than 0.5 μm, whereby a high effectiveness of the sanifying action of the instrument is ensured. The application of fine dispersed aerosols produced both from purified essential oils and directly from live tissues of medicinal plants by the method of resonance high-frequency ultrasonic sublimation substantially broadens the range of therapeutic effects of the producers of medicinal plants, the properties of the produced resonance aerosols differing from the properties of aerosols produced with the aid of conventional devices (including ultrasonic ones).

### REFERENCES

[1] V. A. Agranat (Ed.), “Ultrasonic Technology”, Moscow, Metallurgiya, pp. 341-368 (in Russian).
[2] Chemical Physics Letters. Volume 191, number 5, 1992: “Observation of surface acoustic phonon resonances: application to the CO+O₂ oscillatory reaction on Pt{100}”. V. N. Brezhnev, A. I. Boronin, V. P. Ostanin, V. S. Tupikov and A. N. Belyaev.
[3] 13th European Conference on Surface Science Warwick (UK), August 199:3, “The phonon mechanism of self-organization in catalysis. The example of oscillatory reaction CO+O₂ on Pt{100}.” V. N. Brezhnev, A. I. Boronin, V. P. Ostanin.
[4] Physics of low-dimensional structures. 2/3 (1995), pp. 119-126. “Capabilities of the SAWRS Method in Ultra-High Vacuum Studies” N. V. Brezhnev, A. V. Pryanichnikov, S. P. Suprun, V. S. Tupikov).
[5] Patent RU No. 2039576 C1, IPC A61M 11/00, 1995.
[6] Patent RU No. 2152829. “Device for ultrasonic dispersion of liquid media”. V. N. Brezhnev, N. V. Kazarinova, A. V. Pryanichnikov, A. V. Timonov.
[7] Proceedings of Interregional Scientific and Practical Conference, Omsk, 1998. Bulletin of SORAMN No. 2, 1999.
Use of a new medicinal form—resonance ultradispersed aerosols of essential oils of medicinal plants in treating chronic diseases of respiratory organs (in Russian).
L. D. Sidorova, G. L. Brezhneva, A. S. Logvinenko, E. Yu. Korolenko, V. N. Brezhnev, A. V. Pryanichnikov.
[8] “Meditsinskie Tekhnologii”, No. 1-2, 1995. Meditsinskoe Informatsionnoe Agentstvo, St. Petersburg.
Use of essential oils for preventing intra-hospital infections and treating candidoses {in Russian).
Kazarinova N. V., Muzychenko L. M., Tkachenko K. G., Shurguya A. M., Brezhnev V. N., Usov O. M.
[9] OPINION on using an instrument for individual inhalations. “Berdsk—Ultr Aeroil”. GOKG of Novosibirsk, 1999 (in Russian).
[10] Patent RU No. 2045058, Byulleten' Izobretenij No. 27, 1995, Cl. B01J, Gr. 9/10.
[11] Applied Surface Science, vol. 108, 1, Dec. 23, 1996, pp. 95-103. Original instrumentation for new method of surface investigation. V. N. Brezhnev and V. S. Tupikov.

1. A method for producing an aerosol, consisting in subjecting the medium to be dispersed to the action of ultrasonic oscillations with the help of a source of oscillations, which is made with a possibility of dispersing a liquid and/or loose medium and adjusting the size of aerosol drops by varying the oscillations, the liquid and/or loose medium to be dispersed being acted upon in a standing-wave mode, and the frequency of oscillations being varied within a range close to the resonance frequency of the macrostructure of the liquid and/or loose medium to be dispersed, and/or being maintained equal to the resonance frequency of the macrostructure of the liquid and/or loose medium to be dispersed to form a fine-dispersed aerosol with a size of drops not larger than 0.5 μm, followed by regeneration of the dispersed medium macrostructure.
